(19) United States
(12) Patent Application Publication
(10) Pub. No.: US 2008/0235395 A1
(43) Pub. Date: Sep. 25, 2008

(54) MEDICAL IMAGE TRANSFER CONTROL APPARATUS AND METHOD, AND MEDICAL IMAGE TRANSFER SYSTEM

(75) Inventor: Takuma SAKAMOTO, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/047,915

(22) Filed: Mar. 13, 2008

(30) Foreign Application Priority Data
Mar. 22, 2007 (JP) 2007-073912

(51) Int. Cl. G06F 15/173

(52) U.S. Cl. 709/238

(57) ABSTRACT

A medical image transfer system consists of a plurality of transfer servers for transferring individually a medical image from a modality to an image server, and a control server for controlling the transfer servers. The transfer server sends information tagged to the medical image to the control server, to inquire about a destination of the medical image and an editorial process to be executed on the tagged information to adapt it to the destination. The control sever determines one of the image servers as the destination on the basis of the tagged information as received from the transfer server, and notifies of the destination and the editorial process necessary for the destination as a response to the inquiry. The transfer server executes the assigned editorial process on the tagged information and then transfers the medical image with the processed tagged information to the assigned destination.

### FIELD OF THE INVENTION

The present invention relates to a medical image transfer control apparatus and a medical image transfer control method, which control transferring data of medical images, and a medical image transfer system.

### BACKGROUND OF THE INVENTION

As a medical inspector taking medical images, called a modality, a Computed Tomography (CT) scanner, a Magnetic Resonance Imaging (MRI) machine and a Computed Radiography (CR) device are well-known. Data of the medical image taken by the modality is output to an output apparatus such as an image server storing the images, a displaying device displaying it on a monitor or an image forming device recording it on film. With an increase of the modalities and the output apparatuses, such medical image transfer systems that network a plurality of modalities and output apparatuses to transfer medical images from the modalities to the output devices have been suggested for example from Japanese Laid-open Patent Application No. 2002-133394 and U.S. Patent Application Publication No. 2004/0111299.

Medical image data is recorded, for example, in a Digital Imaging and COmmunications in Medicine (DICOM) standard, which is a standard for the medical image data. Beside the data on an image itself, an image data file of the DICOM-standard includes a DICOM tag containing various tagged information such as information on modality and inspection, hereinafter referred to as the tag data. The medical image transfer apparatuses shown in the above-mentioned patent documents examines the tag data when it receives the medical image from the modality, to designate a transfer destination, i.e. an output device, of the medical image, and also edits the tag data according to the necessary processing in the output device that is designated as the transfer destination. For example, when the medical image data is transferred to the image server, the tag data is used for identifying and sorting the medical images. In case of the display device, the tag data is used for deciding conditions for proper display of the medical image.

What kinds of data items the modality writes in the DICOM tag varies depending upon the kind of modality. Also, what kinds of tag data items are necessary for the processing in the output device often varies depending upon the kind and specification of the output device. The medical image transfer apparatuses disclosed in the above-mentioned patent documents analyze the tag data on a medical image when it is received from an origin, and edit the tag data so as to accord to the transfer destination of the medical image. Hereby, it comes to be possible to execute processing of the medical image properly at any destination.

In recent years, shared use of a medical information center has been progressing for the purpose of spreading a communication network of medical institutions with the growth of intranet and sharing medical information by a plurality of medical institutions. This trend is presumed to accelerate in the future. In keeping with the acceleration of the trend, it is expected that the modalities and output devices connected through the communication network will increase and that connected areas will spread out wider. When the area of the medical network widens and the number of connected medical devices increases, it becomes necessary to install the above-mentioned medical image transfer apparatuses in many dispersed locations.

In order to revise or modify the method of judging and assigning the transfer destination of the medical image or the method of determining the necessary editorial process onto the tag data, it is necessary to change the settings of the individual medical image transfer apparatuses. Where there are many medical image transfer apparatuses, or their installation area spreads out, such maintenance tasks as above will get complicated, take greater time and consume greater labor.

### SUMMARY OF THE INVENTION

In view of the foregoing, a primary object of the present invention is to provide a medical image transfer control apparatus, a medical image transfer control method and a medical image transfer system, which can control a lot of medical image transfer apparatuses efficiently without increasing the load for maintenance.

A medical image transfer control apparatus of the present invention comprises an inquiry accepting device for accepting an inquiry about a destination to which a medical image is to be transferred, the inquiry being sent individually from a plurality of medical image transfer apparatuses that are connected to the medical image transfer control apparatus through a network, accompanied with information related to the medical image, the information being tagged to the medical image as the medical image transfer apparatus receives it from an origin; an assigning device for assigning the destination of the medical image on the basis of the tagged information; and a notifying device for notifying the medical image transfer apparatus of a result of assignment by the assigning device as a response to the inquiry, causing the medical image transfer apparatus to execute a transfer process for transferring the medical image to the assigned destination.

The tagged information preferably includes at least one of information for identifying a modality by which the medical image was taken, information for identifying an inspection using the medical image, and information on a body site from which the medical image was taken.

The assigning device preferably comprises a storage device storing data of available destinations predetermined according to items included in the tagged information. More preferably, the assigning device further assigns an editorial process to be executed on the tagged information according to the assigned destination.

It is preferable to provide the medical image transfer control apparatus with a history recording device for receiving and recording the result of each transfer process executed by the medical image transfer apparatuses.

A medical image transfer control method of the present invention comprises steps of:

accepting an inquiry about a destination to which a medical image is to be transferred, the inquiry being accompanied with information related to the medical image and sent individually from a plurality of medical image transfer apparatuses through a network;

assigning the destination of the medical image on the basis of the related information; and

notifying the image transfer apparatus, which sent the inquiry, of the assigned destination.

A medical image transfer system of the present invention comprises a plurality of medical image transfer apparatuses for executing a transfer process for transferring a medical image from an origin to a destination, and a transfer control apparatus connected to the medical image transfer apparatuses through a network, to control the image transfer apparatuses, wherein each of the medical image transfer apparatuses comprises a device for inquiring the transfer control apparatus about a destination to which a medical image is to be transferred, by sending information tagged to the medical image, and the transfer control apparatus comprises a device for accepting the inquiry accompanied with the tagged information from the medical image transfer apparatus, a device for assigning the destination of the medical image on the basis of the tagged information, and a device for notifying the medical image transfer apparatus of a result of assignment by the assigning device as a response to the inquiry.

Because the destination of each medical image is assigned according to the tagged information of the medical image in response to an inquiry that is sent from the medical image transfer apparatus each time it receives the medical image, there is no need for revising setup data and programs in the individual medical image transfer apparatuses even when the method of deciding and assigning the transfer destination of the medical image has changed. So the maintenance task will not remarkably increase with an increase in number of the medical image transfer apparatuses.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a conceptual diagram illustrating a structure of a medical image transfer system;

FIG. 2 is an explanatory diagram illustrating a data file of a medical image;

FIG. 3 is a block diagram illustrating a transfer server and a control server of the medical image transfer system;

FIG. 4 is an explanatory diagram illustrating table data for assigning a transfer destination of a medical image;

FIG. 5 is an explanatory diagram illustrating table data for assigning an editorial process; and

FIG. 6 is a flowchart illustrating a sequence of processing for transferring a medical image.

### DESCRIPTION OF THE PREFERRED EMBODIMENTS

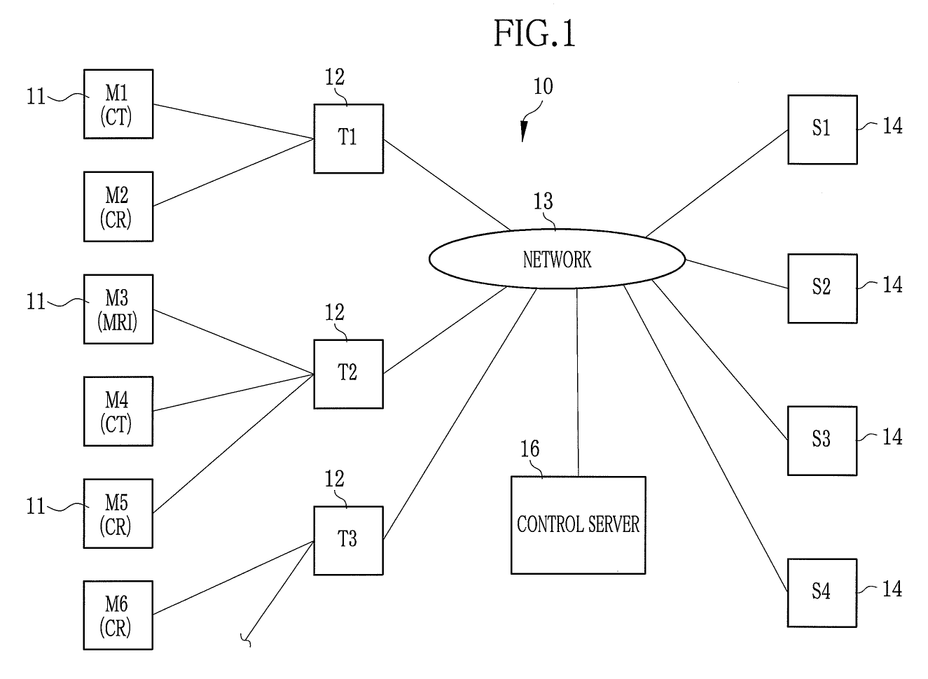

A medical image transfer system 10 shown in FIG. 1 is provided with modalities 11 (M1, M2, M3, M4, M5 and M6), medical image transfer servers 12 (T1, T2 and T3) connected to the modalities 11, hereinafter referred to as the transfer servers 12, image servers 14 (S1, S2, S3 and S4) to which the respective transfer servers 12 are connected through a communication network 13, and a medical image transfer controlling server 16, hereinafter referred to as the control server 16, which controls the respective transfer servers 12. The respective modalities 11 are medical inspectors which take such medical images as CT, CR and MRI to serve for a variety of medical inspections. The medical images are transferred from the modalities 11 through the transfer severs 12 to the image servers 14.

The communication network 13 is, for example, a Local Area Network (LAN) laid down in a medical facility. The image servers 14 are provided, for example, in respective departments of the medical facility. The respective modalities 11 send the taken medical images respectively to the transfer servers 12. After receiving the medical images, the transfer servers 12 transfer them to the respective image servers 14 to store the medical images.

The transfer servers 12 are respectively connected to the modalities 11 through communication cables. According to this embodiment, the respective modalities 11 are connected to the fixed transfer servers 12, i.e. access ends of the communication cables are respectively fixed. However, it is possible not to fix the accepters of the respective modalities 11, but make many-to-many connection of the modalities 11 to the transfer servers 12 through a LAN or the like. Hereby, even if one of the transfer servers 12 breaks down, there is a detour to another transfer server 12, which enhances the resistance to system failure and the availability of the medical image transfer system 10.

The control server 16 and the respective transfer servers 12 are connected through the communication network 13. When one of the transfer-servers 12 receives a medical image from one of the modalities 11, the transfer server 12 inquires of the control server 16 about a transfer destination of the received medical image and necessary processing for editing the tag data of the medical image. The control server 16 responds to the inquiry and controls the transfer servers 12 individually by assigning the transfer destination and the editorial process necessary for the tag data.

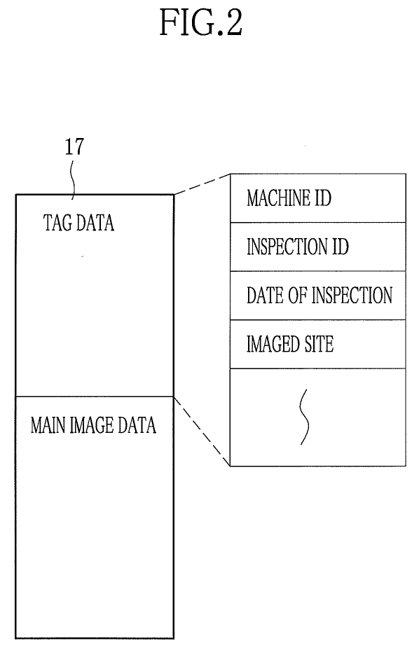

FIG. 2 is an explanatory diagram illustrating a data file 17 of the medical image. The data file 17 is recorded according to the DICOM standard, and consists of two parts: main image data (data on an image itself) and the tag data contained in DICOM tag. Items included in the tag data are for example a machine ID as information for identifying an origin modality by which a medical image was taken, an inspection ID as information given to each individual inspection, a date of inspection on which the inspection was carried out, and information on imaged body site such as head or chest, from which the medical image was taken for the inspection.

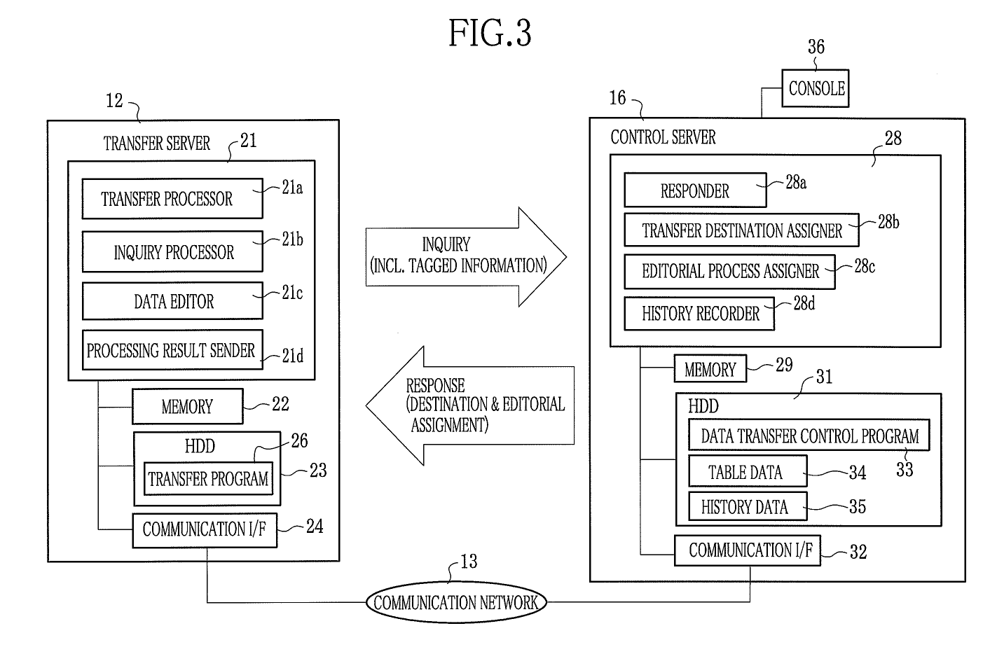

As shown in FIG. 3, the transfer server 12 and the control server 16 are respectively made for example based on a personal computer or workstation installed with application programs.

The transfer server 12 is provided with a CPU 21, a memory 22, a hard disk drive (HDD) 23 and a communication I/F 24. The communication I/F 24 controls a communications protocol that accords to the communication network 13. The HDD 23 stores operation systems and a transfer program 26. The memory 22 is a working memory used by the CPU 21 to execute processing. The CPU 21 functions as a transfer processor 21a, an inquiry processor 21b, a data editor 21c and a processing result seeder 21d by loading the transfer program 26 from the HDD 23 to the memory 22 and by executing a sequence of processing described in the program.

The transfer processor 21a receives the medical image from the modality 11 and executes a transfer process to send the medical image to the image server 14. The inquiry processor 21b executes an inquiry process for inquiring of the control server 16 about the transfer destination of the received medical image and the editorial process necessary for the tag data of the medical image. Upon receipt of a medical image data file 17, the inquiry processor 21b reads out the tag data from the data file 17 and sends an inquiry accompanied with the tag data to the control server 16. Responding to the inquiry, the control server 16 sends back a result of assignment as an instruction to the transfer server 12.

The assignment includes a transfer destination assigned to the medical image and an editorial assignment, i.e. an editorial process to be executed on the tag data, which is predetermined and decided according to the transfer destination. The data editor 21c edits the tag data according to the editorial assignment, by overwriting data on, deleting data from or adding data to the tag data. For example, the data editor 21c replaces a data item for identifying the medical image with a unique ID, so that the ID of the medical image does not overlap with others in the image server 14, or delete information from such an item that must be blank. The transfer processor 21a sends the medical image data file 17 to the image server 14 that is designated as the transfer destination, after the tag data is edited for the assigned transfer destination. The processing result sender 21d sends the results of the editorial process and transfer process to the control server 16.

The control server 16 is provided with a CPU 28, a memory 29, a HDD 31 and a communication I/F 32. The communication I/F 32a controls the communications protocol according to the communication network 13. The HDD 31 stores table data 34 and history data 35 as well as operation systems and a transfer controlling program 33. The memory 29 is the working memory used by the CPU 28 to execute processing. The CPU 28 functions as a responder 28a, a transfer destination assigner 28b, an editorial process assigner 28c and a history recorder 28d by loading the transfer controlling program 33 from the HDD 31 to the memory 29 and by executing a sequence of processing described in the program.

The responder 28a receives the inquiry from the transfer server 12 and responds to the inquiry. The transfer destination assigner 28b designates the transfer destination according to the content of the tag data received with the inquiry. The editorial process assigner 28c assigns an editorial process for the above-mentioned tag data, which is decided according to the transfer destination assigned by the transfer destination assigner 28b. To decide the transfer destination and the editorial process, the transfer destination assigner 28b and the editorial process assigner 28c refer to the table data 34.

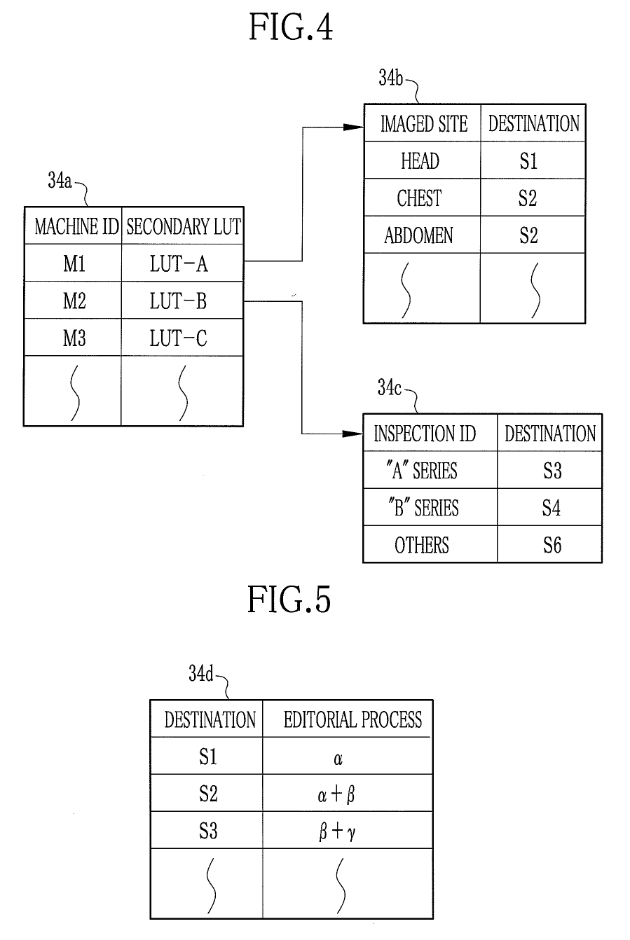

As shown for example in FIGS. 4 and 5, the table data 34 consists of Look Up Tables (LUT) 34a, 34b, 34c and 34d. The LUTs 34a, 34b and 34c are table data used for designating the transfer destination, and constitute a transfer destination memory storing data of transfer destinations predetermined according: to the content of the tag data. The LUT 34d is table data used for deciding the editorial assignment, and constitutes an editorial content memory storing the predetermined contents of how to edit the tag data according to the transfer destination.

The LUTs 34a, 34b, 34c and 34d are connected in cascade as described below, so that detailed sorting can be done by referring to several items of the tag data. The LUT 34a is a primary LUT showing the relation between respective machine IDs (M1, M2, M3 . . . ) of the modalities 11 and corresponding secondary LUTs (LUT-A, LUT-B, LUT-C . . . ). In the illustrated example, the LUTs 34b and 34c are included in the secondary LUTs. The LUT 34b is table data showing the relation between the imaged sites as the objects of the medical images and the transfer destinations. The LUT 34c is table data showing the relation between the inspection IDs and the transfer destinations.

The transfer destination assigner 28b reads out the machine ID of the modality 11 from the tag data and then refers to the primary LUT 34a to read out the secondary LUT corresponding to the machine ID. When, for example, the machine ID is M1, the corresponding LUT 34b (LUT-A) is read out. When the machine ID is M2, the corresponding LUT 34c (LUT-B) is read out.

When the LUT 34b (LUT-A) is read out as the secondary LUT, information on the imaged site is read out from the tag data, and the transfer destination is read out from the LUT 34b according to the imaged site. When the imaged site is head, the image server S1 is read out as the transfer destination. In case of a chest or abdomen, the image server S2 is read out as the destination. Sorting the transfer destinations according to the imaged sites in this manner makes it possible to send images of a body site to a destination predetermined for this imaged site exclusively. For example, only images of heads are sent to the image server S1. Where the image servers 14 take charge of different diagnosis and treatment departments from each other, it is convenient to sort the medical images according to the imaged sites from which the images are taken.

When the LUT 34c (LUT-B) is read out as the secondary LUT, the inspection ID is read out from the tag data, and the transfer destination is read out from the LUT 34c according to the inspection ID. When, for example, the read inspection ID includes a letter “A”, the image server S3 is read out as the destination. When the read inspection ID includes a letter “B”, the image server S4 is read out as the destination. Where the image servers 14 take charge of different kinds of inspections from each other, it is convenient to sort the medical images according to the inspection ID. Hereby, the transfer destination of the medical image is determined based on the LUTs 34a and 34b.

The number of steps of the cascade connection of LUTs is not limited to two. It is possible to connect LUTs in three and more steps of cascade, which enables more detailed sorting of the medical images for the transfer destinations. Although the machine ID is used as an entry to the primary LUT in the above embodiment, it is possible to use an ID or the name of a medical facility as an entry to the primary LUT in a case where the modalities 11 are dispersed in several medical facilities. In a case where the modalities 11 are dispersed across a country, the area where the modality 11 exists is usable as an entry to the primary LUT. Thus, many variations from the above embodiment are possible.

The editorial process assigner 28c reads out an editorial process from the LUT 34d according to the transfer destination determined by the transfer destination assigner 28b. When, for example, the transfer destination is the image server S1, an editorial process α is necessary for the tag data. When the transfer destination is the image server S2, an editorial process β is added to the process α as the editorial assignment.

The determined transfer destination and editorial assignment are sent back to a sender of the inquiry by the responder 28a. The history recorder 28d records the processing result that is sent from the processing result sender 21d of each transfer server 12, to record it in a transfer history. The transfer history is stored for example in the HDD 31 as the history data 35. The processing result includes the assignment sent back as the response to the inquiry, the result of the transfer process, and the result of the editorial process on the tag data. The processing result is recorded with the ID of the transfer server 12 that sends the processing result, and the ID of the transferred medical image. In this way, the transfer history of the respective transfer servers 12 is managed by the control server 16 in an integrated fashion, which contributes to speeding up the analysis to find the cause of a trouble.

A console 36 consists of a monitor displaying an operation screen of the control server 16 and operating members including a keyboard and a mouse. The operator can revise the table data 34 through the console 36. It is also possible to make the table data 34 revisable by administrator's remote logging in the control server 16.

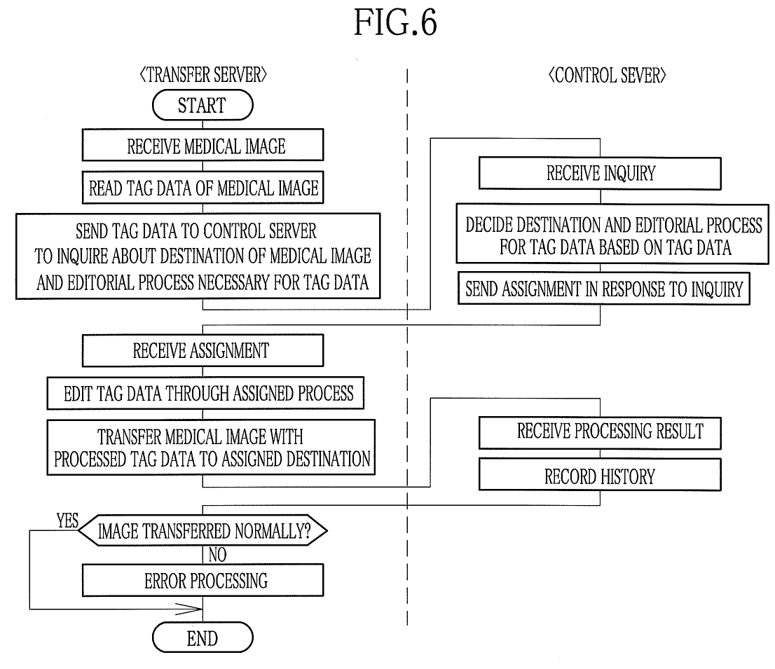

Now the operation of the above described embodiment will be explained while referring to a flowchart shown in FIG. 6. Upon receipt of the medical image from the modality 11, the transfer server 12 reads the tag data out of the medical image and then sends the inquiry including the tag data to the control server 16. The control server 16 receives the inquiry and accepts it. After accepting the inquiry, the control server 16 determines the transfer destination based on the tag data, and the editorial assignment according to the transfer destination, and informs the transfer server 12 of the transfer designation and:the editorial assignment.

After receiving the editorial assignment, the transfer server 12 edits the tag data according to the assignment, and then transfers the medical image including the edited tag data to the assigned transfer destination. After completing these processing, the transfer server 12 sends the processing result to the control server 16. The control server 16 records the received processing result in the history data 35.

After completing the transfer process normally, the transfer server 12 is set to a waiting state where the transfer server 12 waits for the next request for transfer. When the transfer process is not normally completed, the transfer server 12 executes an error processing. In the error processing, the transfer server 12 first retries the transfer process to the image server 14 a given number of times. If the transfer server 12 gets no response from the assigned transfer destination and can not complete the transfer process normally again even after the given times of retries of the transfer process, the transfer server 12 informs the control server 16 that the assigned transfer destination didn't respond, and inquires about another transfer destination. Then the control server 16 refers the transfer server 12 to another transfer destination that is predetermined as a backup transfer destination for the previously assigned transfer destination. According to the information, the transfer server 12 executes the transfer process again. The control server 16 also records these processing results in the history data 35.

To revise the method of assigning the transfer destination and editorial content of processing the tag data, a system administrator changes the content of the table data 34. Because the control server 16 controls the respective transfer servers 12 upon receipt of an inquiry or request for reference from the transfer servers 12, there is no need to attempt change tasks individually to the respective transfer servers 12 and the load of the maintenance tasks does not increase, even with the increased number of the transfer servers 12.

In the above described embodiment, the medical image transfer system is the network built up in one medical facility. It is, however, also possible to build up the medical image transfer system by networking plural medical facilities. The wider the network becomes, the more effectively the present invention works.

In the above described embodiment, the respective transfer servers inquire of the control server about the transfer destination and other information at each transfer process of one medical image. It is also possible for the control server to deliver basic data for judging transfer destinations and editorial assignments to the respective transfer servers at regular intervals, so that the respective transfer servers can judge the transfer destination and editorial assignment according to the basic data. This embodiment, however, involves a risk that the processing can not be unified when there is a time lag in the updating timing of one transfer server to another, or that the respective transfer servers cannot judge by the latest basic data when there is a delay of delivery timing and so on. Therefore, the first embodiment, in which the transfer server makes an inquiry for every transfer process, has a merit of avoiding such disadvantage.

In the above described embodiment, the transfer server executes the edit processing of the tag data. It is alternatively possible that the control server executes the edit processing and sends the processed tag data to the transfer server. It is also possible that the control server assigns only the transfer destination, but does not give the editorial assignment.

In the above described embodiment, an output device, that is the transfer destination of the medical image, is the image server. Instead, a display device or an image forming device can be a transfer destination. The respective numbers of modalities, transfer servers and image servers are variable and not limited to the above embodiment. Although the control server and the transfer servers are respectively independent devices in the above described embodiment, it is possible to provide one of the transfer servers with the function of the control server. It is also possible to dispose a plurality of control servers when the number of transfer servers greatly increases and the load on the control server becomes too heavy for one control server alone.

Thus, the present invention is not to be limited to the above embodiments but, various modifications will be possible without departing from the scope of claims appended hereto.

What is claimed is:

1. A medical image transfer control apparatus comprising:
an inquiry accepting device for accepting an inquiry about a destination to which a medical image is to be transferred, said inquiry being sent individually from a plurality of medical image transfer apparatuses that are connected to said medical image transfer control apparatus through a network, accompanied with information related to the medical image, said information being tagged to the medical image as said medical image transfer apparatus receives it from an origin;
an assigning device for assigning the destination of the medical image on the basis of said tagged information; and
a notifying device for notifying said medical image transfer apparatus of a result of assignment by said assigning device as a response to the inquiry, causing said medical image transfer apparatus to execute a transfer process for transferring the medical image to the assigned destination.

2. A medical image transfer control apparatus as recited in claim 1, wherein the tagged information includes at least one of information for identifying a modality by which the medical image was taken, information for identifying an inspection using the medical image, and information on a body site from which the medical image was taken.

3. A medical image transfer control apparatus as recited in claim 1, wherein said assigning device comprises a storage device storing data of available destinations predetermined according to items included in the tagged information.

4. A medical image transfer control apparatus as recited in claim 1, wherein said assigning device further assigns an editorial process to be executed on the tagged information according to the assigned destination.

5. A medical image transfer control apparatus as recited in claim 4, said assigning device comprises a storage device storing necessary editorial processes predetermined according to respective destinations.

6. A medical image transfer control apparatus as recited in claim 1, further comprising a history recording device for receiving and recording the result of each transfer process executed by said medical image transfer apparatuses.

7. A medical image transfer control method comprising steps of:
accepting an inquiry about a destination to which a medical image is to be transferred, said inquiry being accompanied with information related to the medical image and sent individually from a plurality of medical image transfer apparatuses through a network;
assigning the destination of the medical image on the basis of the related information; and
notifying the image transfer apparatus, which sent the inquiry, of the assigned destination.

8. A medical image transfer system comprising:
a plurality of medical image transfer apparatuses for executing a transfer process for transferring a medical image from an origin to a destination; and
a transfer control apparatus connected to said medical image-transfer apparatuses through a network, to control said image transfer apparatuses, wherein
each of said medical image transfer apparatuses comprises a device for inquiring said transfer control apparatus about a destination to which a medical image is to be transferred, by sending information tagged to the medical image; and
said transfer control apparatus comprises a device for accepting the inquiry accompanied with the tagged information from said medical image transfer apparatus, a device for assigning the destination of the medical image on the basis of the tagged information; and a device for notifying said medical image transfer apparatus of a result of assignment by said assigning device as a response to the inquiry.

9. A medical image transfer system as recited in claim 8, wherein said medical image transfer apparatuses are connected through said network to a plurality of image output apparatuses, and said assigning device assigns one of said image output apparatuses as the destination and assigns an editorial process to be executed on the tagged information according to the assigned image output apparatus.
